(19) United States
(12) Patent Application Publication
(10) Pub. No.: US 2026/0004087 A1
(43) Pub. Date: Jan. 1, 2026

(54) TASK-ORIENTED DIALOGUE IMPLEMENTATION METHOD

(71) Applicant: BEIJING BAIDU NETCOM SCIENCE TECHNOLOGY CO., LTD., Beijing (CN)

(72) Inventors: Shunke BAO, Beijing (CN); Yubo XIANG, Beijing (CN); Shuai CHEN, Beijing (CN)

(73) Assignee: BEIJING BAIDU NETCOM SCIENCE TECHNOLOGY CO., LTD., Beijing (CN)

(21) Appl. No.: 19/319,130

(22) Filed: Sep. 4, 2025

(30) Foreign Application Priority Data
Dec. 3, 2024 (CN) 202411765014.2

(51) Int. Cl. G06F 40/40; G06N 3/08

(52) U.S. Cl. CPC G06F 40/40; G06N 3/08

(57) ABSTRACT

Provided is a task-oriented dialogue implementation method relating to artificial intelligence fields such as deep learning, large language models, natural language processing and intelligent agents, which can be applied to intelligent interaction scenarios such as intelligent customer service, intelligent outbound calling, and intelligent marketing. The task-oriented dialogue implementation method may include: acquiring a question to be answered; generate an answer corresponding to the question by using a task-oriented dialogue model, the answer is generated by the task-oriented dialogue model according to model configuration information, the model configuration information includes a dialogue flow corresponding to the task-oriented dialogue model, and the dialogue flow is written in text form.

### CROSS-REFERENCE TO RELATED APPLICATION

The present disclosure claims the priority and benefit of Chinese Patent Application No. 202411765014.2, filed on Dec. 3, 2024. The disclosure of the above application is incorporated herein by reference in its entirety.

### TECHNICAL FIELD

The present disclosure relates to the field of artificial intelligence technology, particularly to the fields of deep learning, large language models, natural language processing, and intelligent agents, and more particularly to a task-oriented dialogue implementation method.

### BACKGROUND

Currently, task-oriented dialogue has been widely applied in various scenarios, with products such as intelligent customer service, intelligent outbound calling and intelligent marketing being typical application scenarios of the task-oriented dialogue.

### SUMMARY

A task-oriented dialogue implementation method includes:
acquiring a question to be answered; and
generate an answer corresponding to the question by using a task-oriented dialogue model, where the answer is generated by the task-oriented dialogue model according to corresponding model configuration information, where the model configuration information includes: a dialogue flow corresponding to the task-oriented dialogue model, where the dialogue flow is written in text form.

An electronic device includes:
at least one processor; and
a memory communicatively connected to the at least one processor; wherein,
the memory stores instructions executable by the at least one processor to cause the at least one processor to perform the method as described above.

A non-transitory computer-readable storage medium storing computer instructions for causing a computer to perform the method as described above.

It should be understood that the content described in this section is not intended to identify key or important features of the embodiments of the present disclosure, nor is it used to limit the scope of the present disclosure. Other features of the present disclosure will become readily understandable through the following specification.

### BRIEF DESCRIPTION OF THE DRAWINGS

The drawings are used for better understanding the present solution and do not constitute a limitation of the present disclosure. In the drawings,

FIG. 1 is a flowchart of an embodiment of a task-oriented dialogue implementation method of the present disclosure;

FIG. 2 is a schematic diagram of the dialogue flow generated by writing according to the present disclosure;

FIG. 3 is a schematic diagram of the overall implementation process of a task-oriented dialogue implementation method of the present disclosure;

FIG. 4 is a flowchart of an embodiment of a task-oriented dialogue model training method of the present disclosure;

FIG. 5 is a schematic diagram showing the composition structure of a task-oriented dialogue implementation apparatus 500 according to an embodiment of the present disclosure;

FIG. 6 is a schematic diagram showing the composition structure of a task-oriented dialogue model training apparatus 600 according to an embodiment of the present disclosure; and

FIG. 7 shows a schematic block diagram of an electronic device 700 that can be used to implement embodiments of the present disclosure.

### DETAILED DESCRIPTION OF EMBODIMENTS

The following description of exemplary embodiments of the present disclosure is made in conjunction with the drawings, which includes various details of the embodiments of the present disclosure to facilitate understanding, and should be considered as merely exemplary. Therefore, those skilled in the art should recognize that various changes and modifications can be made to the embodiments described herein without departing from the scope and spirit of the present disclosure. Similarly, for clarity and conciseness, descriptions of known functions and structures are omitted in the following description.

Furthermore, it should be understood that the term “and/or” used herein is merely a description of the associative relationship between associated objects, indicating that three relationships can exist. For example, A and/or B can indicate: A exists alone, A and B exist simultaneously, or B exists alone. Additionally, the character “/” used in this document generally indicates an “or” relationship between the associated objects before and after it.

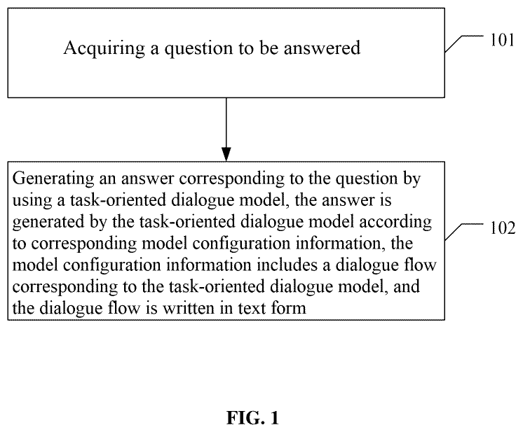

FIG. 1 is a flowchart of an embodiment of a task-oriented dialogue implementation method of the present disclosure. As shown in FIG. 1, the method includes the following specific implementation methods.

In step 101, acquire a question to be answered.

In step 102, generate an answer corresponding to the question by using a task-oriented dialogue model, where the answer is generated by the task-oriented dialogue model according to corresponding model configuration information, where the model configuration information includes a dialogue flow (SOP, Session Operating Procedure) corresponding to the task-oriented dialogue model, where the dialogue flow is written in text form.

Traditional task-oriented dialogue is typically implemented based on a Natural Language Understanding (NLU) module, a Dialog Management (DM) module, and a Natural Language Generation (NLG) module. The NLU module can use a discriminative model to identify user intentions, the DM module serves as the central control of the entire dialogue, responsible for deciding what strategy to use for the current dialogue, and the NLG module is used to convert the processing results of the DM module into natural language, typically implemented through templates and enumeration. Although this approach has good dialogue control capabilities, it requires significant operational costs, and the generated answers are usually rigid and unnatural, seriously affecting the user's dialogue experience.

Correspondingly, a large language model-based task-oriented dialogue implementation method has been proposed, where the large language model generates corresponding answers to questions input by a user. However, this approach requires pre-arranging the entire dialogue using editable workflows, and a workflow contains multiple nodes, with most nodes requiring the writing of a prompt to control the output of the large language model, making the implementation complex and unfriendly to personnel without relevant knowledge, requiring specialized learning, thus increasing human resource and time costs. Additionally, the dialogue latency is high, as one round of dialogue typically requires processing through several large language models to output the corresponding answer, thereby reducing dialogue efficiency.

By adopting the solution described in the above method embodiment, a dialogue flow can be pre-written in text form and used as model configuration information corresponding to the task-oriented dialogue model. Thus, for a question input by a user, the task-oriented dialogue model can directly generate a corresponding answer based on the model configuration information, meaning only one large language model call is needed to complete a round of dialogue, thereby reducing latency and improving dialogue efficiency. Moreover, the generated answer is natural and fluent, enhancing the user's dialogue experience. Additionally, the dialogue flow can be written in text form, which is very simple and convenient, thus lowering the usage threshold of the task-oriented dialogue model and saving human resource and time costs.

It should be noted that the solution described in the above method embodiment can be executed by a large language model-based agent. An agent refers to a computer program based on a large language model that possesses planning and thinking capabilities, memory capabilities, and the ability to use tool functions, capable of autonomously completing given tasks.

The agent can receive input information and determine a target task based on the input information, determine the required large language model to be called based on the target task, and then obtain output information through calling the large language model for related processing.

Specifically, in the solution described in the method embodiment of the present disclosure, the input information can be a question to be answered, the target task can be a task-oriented dialogue, the called large language model can be a task-oriented dialogue model, and the output information can be the answer corresponding to the question generated using the task-oriented dialogue model.

For ease of distinction, the user who inputs questions to the task-oriented dialogue model is referred to as a first user.

The task-oriented dialogue model in the solution of the present disclosure is a large language model capable of autonomous response planning. The large language model (LLM) is a deep learning model trained using large amounts of text data, capable of generating natural language text or understanding the meaning of language text.

Correspondingly, in the solution of the present disclosure, the agent can acquire a question input by the first user, and can use the task-oriented dialogue model to generate an answer corresponding to the question input by the first user, and then return the answer to the first user. The answer can be generated by the task-oriented dialogue model according to corresponding model configuration information, and the model configuration information may include: a dialogue flow corresponding to the task-oriented dialogue model.

In some embodiments of the present disclosure, the dialogue flow may include: a dialogue flow written for a predetermined dialogue scenario, correspondingly, the acquired question may include: a question acquired under the dialogue scenario.

The predetermined dialogue scenarios may include government affairs Q&A scenarios, e-commerce after-sales intelligent customer service scenarios, etc.

The dialogue flow can be written by a second user. For example, in an e-commerce after-sales intelligent customer service scenario, the second user can be an online store owner on a shopping platform, or a writer commissioned by the store owner, who can use the task-oriented dialogue model to implement the store's after-sales intelligent customer service function. Correspondingly, the second user can write and generate corresponding dialogue flows.

Through the above processing, the written and generated dialogue flow can be matched with a specific dialogue scenario, so that an accurate corresponding answer can be generated for a question input by the first user under the corresponding dialogue scenario.

The dialogue flow can be written according to a predetermined writing format. In some embodiments of the present disclosure, the dialogue flow may include: at least two steps written according to a predetermined step writing principle, each step may include: the objective to be achieved by the step, and the requirement to be followed for achieving the objective.

The specific content included in the step writing principle can be determined according to actual needs. For example, steps can be written according to the principle that fewer steps in the dialogue flow are better, and clearer boundaries between steps are better. Clear boundaries between steps typically mean minimizing content overlap between steps, with each step have well-defined objectives and no redundancy.

Each step may include one objective, which can be described in one sentence and should use as few words as possible. If describing an objective in a step requires many words, it indicates that the step is not well abstracted and should be reconsidered for redesign.

Each step also needs to include a requirement corresponding to the objective, namely the requirement that need to be followed to achieve the corresponding objective, such as what language to use for replies, what content to reply first followed by what content, which step to jump to based on different user inputs, etc. Each step can include multiple requirements.

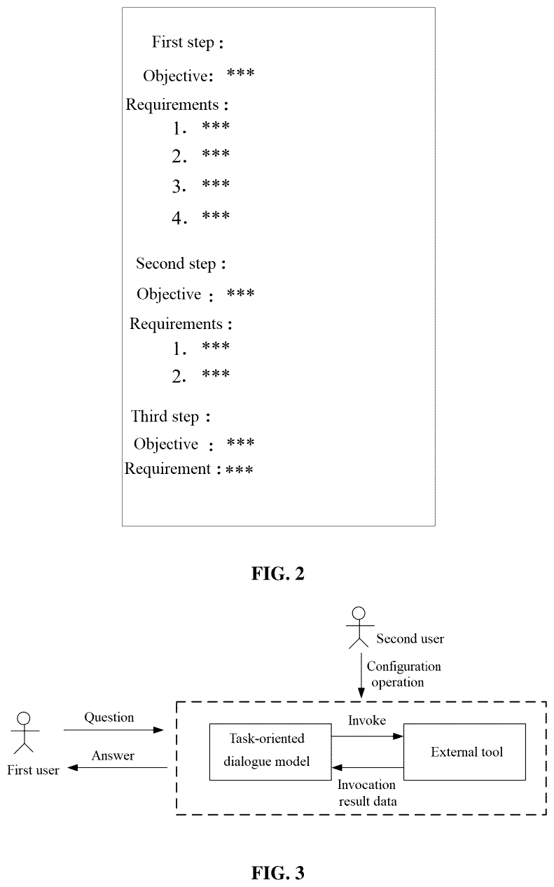

FIG. 2 is a schematic diagram of a dialogue flow written and generated according to the present disclosure. As shown in FIG. 2, assuming there are three steps in total, it can be seen that each step may include one objective, and each objective may correspond to one or multiple requirements.

For example, the objective of the first step may be: determine a user intent, respond to the users politely and concisely, with 4 corresponding requirements being: Requirement 1, determine the user's intent, respond to the user politely and concisely; Requirement 2, when the user express an intent related to “urging order delivery” or “complaining about slow food preparation or delivery”, proceed to the second step; Requirement 3, when user's intent is not related to “urging order delivery” or “complaining about slow food preparation or delivery”, output specified script “Dear customer, welcome to . . . , are you experiencing any delivery-related issues?”; Requirement 4, after using the specified script to inquire, if the user still haven't expressed intent related to “urging order delivery” or “complaining about slow food preparation or delivery”, explain to the user that the service only handles delivery-related matters and cannot help with other issues.

Through the above processing, an unified constraint on the content and form of the dialogue flow can be achieved, thereby facilitating the writing of the dialogue flow by the second user and making it easier for the task-oriented dialogue model to understand and use the dialogue flow.

In addition to the dialogue flow, in some embodiments of the present disclosure, the model configuration information may also include: at least one external tool corresponding to the task-oriented dialogue model. Correspondingly, the answer corresponding to the question input by the first user may include: an answer directly generated by the task-oriented dialogue model in response to determining that no external tool is needed, and an answer generated by the task-oriented dialogue model in combination with obtained external data in response to determining that an external tool is needed, where the external data is invocation result data obtained by the task-oriented dialogue model through invoking the external tool.

There is no limitation on the specific number of external tools, and which external tools to configure can be determined according to actual needs.

Thus, for the task-oriented dialogue model, after receiving the question input by the first user, determination can be made first. If it determines that a corresponding answer can be generated without using an external tool, it can directly generate the answer. If it determines that an external tool is needed to generate the answer, it needs to automatically determine (i.e., plan) which external tool is needed, invoke the determined external tool to obtain invocation result data, then determine the invocation result data as the obtained external data, and generate the answer in combination with the external data.

In other words, whether to invoke an external tool and which external tool(s) to invoke can be determined by the task-oriented dialogue model itself, making it very flexible and convenient.

Additionally, in some embodiments of the present disclosure, in response to determining that the external tool include an external tool requiring material configuration, the model configuration information may also include: textual resource information configured for the external tool requiring material configuration.

For example, if an external tool is a document retrieval tool, then corresponding textual resource information needs to be configured for that external tool.

By adopting the above processing method, external data obtained from the external tool can be used to compensate for the limitations of the task-oriented dialogue model's own capabilities, thereby improving the accuracy of generated answers.

Combining the above introduction, FIG. 3 shows a schematic diagram of the overall implementation process of a task-oriented dialogue implementation method of the present disclosure. As shown in FIG. 3, for a predetermined dialogue scenario, the second user can perform some simple configuration operations in advance, such as: writing and generating a corresponding dialogue flow, configuring a corresponding external tool, and configuring corresponding textual resource information for the external tool requiring material configuration, etc., with very low operational costs. For example, in an e-commerce after-sales intelligent customer service dialogue scenario, the second user can write and generate a corresponding dialogue flow, and configure some external tools, such as document retrieval tools, and configure some after-sales policy documents as materials corresponding to the document retrieval tools. Afterwards, the first user can engage in dialogue with the task-oriented dialogue model, meaning that for a question input by the first user, the task-oriented dialogue model can generate a corresponding answer and return it to the first user. The task-oriented dialogue model can invoke an external tool and obtain returned invocation result data as external data, and then generate the answer in combination with the external data. The first user can be any user who needs to engage in dialogue with the task-oriented dialogue model.

The task-oriented dialogue model can be obtained through pre-training. The following explains the training method for the task-oriented dialogue model.

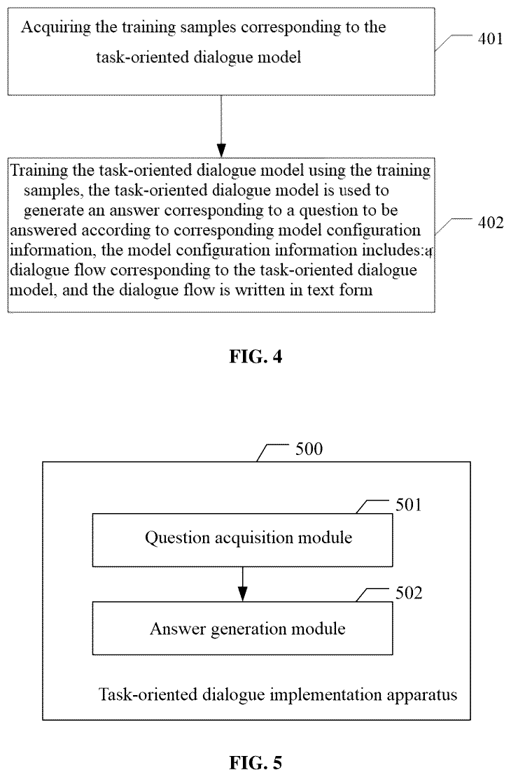

FIG. 4 is a flowchart of an embodiment of a task-oriented dialogue model training method of the present disclosure.

FIG. 4 shows the following specific implementation.

In step 401, acquire training samples corresponding to the task-oriented dialogue model.

In step 402, train the task-oriented dialogue model using the training samples, where the task-oriented dialogue model is used to generate an answer corresponding to a question to be answered according to corresponding model configuration information, where the model configuration information includes: a dialogue flow corresponding to the task-oriented dialogue model, where the dialogue flow is written in text form.

By adopting the solution described in the above method embodiment, the task-oriented dialogue model can be trained using acquired training samples. After training, a dialogue flow can be pre-written in text form and used as model configuration information corresponding to the task-oriented dialogue model. Thus, for a question input by a user, the task-oriented dialogue model can directly generate a corresponding answer based on the model configuration information, meaning only one large language model call is needed to complete a round of dialogue, thereby reducing latency and improving dialogue efficiency. Moreover, the generated answer is natural and fluent, enhancing the user's dialogue experience. Additionally, the dialogue flow can be written in text form, which is very simple and convenient, thus lowering the usage threshold of the task-oriented dialogue model and saving human resource and time costs.

The model capabilities of the task-oriented dialogue model determine the effectiveness of the dialogue, therefore it is necessary to construct sufficient training samples to train the task-oriented dialogue model.

In some embodiments of the present disclosure, the training samples may include: a first type of training samples, each set of the first type of training samples may include: a question, a dialogue flow of a dialogue scenario corresponding to the question, an answer corresponding to the question, and intermediate reasoning process information needed by the task-oriented dialogue model for generating the answer.

There are no restrictions on how to obtain various information in the training samples. For example, questions can be searched from the internet, or obtained from historical dialogue information of other dialogue products, and other information can be manually annotated. The intermediate reasoning process refers to the intermediate thinking process that the task-oriented dialogue model needs to undergo to generate an answers corresponding to a question. With the help of intermediate reasoning process information, the task-oriented dialogue model can better learn how to generate an answers corresponding to a question, improving the training effect of the model.

In some embodiments of the present disclosure, the training samples may also include a second type of training samples, each of the second type of training samples may include: a question, a dialogue flow of a dialogue scenario corresponding to the question, a name and function description information of an external tool usable by the task-oriented dialogue model, an answer corresponding to the question generated in combination with external data, and intermediate reasoning process information needed by the task-oriented dialogue model for generating the answer, where the external data is invocation result data obtained through invoking the external tool.

The specific content included in the function description information of the external tool can be determined according to actual needs, such as function introduction and usage instructions.

With the help of the second type of training samples, the task-oriented dialogue model can learn how to generate an answer corresponding to a question with the assistance of an external tool. In some cases, the task-oriented dialogue model alone may not be able to generate the answer. Correspondingly, it can determine which external tool need to be called, invoke the determined external tool to obtain invocation result data, then determine the invocation result data as the obtained external data, and generate the answer in combination with the external data.

By adopting the above processing method, external data obtained from an external tool can be used to compensate for the limitations of the task-oriented dialogue model's own capabilities, thereby improving the accuracy of generated answer.

Additionally, in some embodiments of the present disclosure, the dialogue flow may include: at least two steps written according to a predetermined step writing principle, where each step may include: the objective to be achieved by the step, and the requirement to be followed for achieving the objective.

After constructing sufficient training samples, the task-oriented dialogue model can be trained using these samples. After training is completed, the task-oriented dialogue model can be applied to actual task-oriented dialogues, such as generating answers corresponding to questions input by the first user according to corresponding model configuration information.

It should be noted that for the preceding method embodiments, for simplicity of description, they are all expressed as a series of action combinations. However, those skilled in the art should know that the present disclosure is not limited by the described action sequence, because according to the present disclosure, some steps can be performed in other orders or simultaneously. Secondly, those skilled in the art should also know that the embodiments described in the specification are all preferred embodiments, and the actions and modules involved are not necessarily essential to the present disclosure. Additionally, for parts not detailed in one embodiment, reference can be made to relevant descriptions in other embodiments.

The above is an introduction to the method embodiments. The following further explains the solution of the present disclosure through apparatus embodiments.

FIG. 5 is a schematic diagram showing the composition structure of a task-oriented dialogue implementation apparatus 500 according to an embodiment of of the present disclosure. As shown in FIG. 5, the apparatus includes: a question acquisition module 501 and an answer generation module 502.

The question acquisition module 501 is configured to acquire a question to be answered.

The answer generation module 502 is configured to use a task-oriented dialogue model to generate an answer corresponding to the question, the answer is generated by the task-oriented dialogue model according to corresponding model configuration information, the model configuration information includes a dialogue flow corresponding to the task-oriented dialogue model, where the dialogue flow is written in text form.

By adopting the solution described in the above apparatus embodiment, a dialogue flow can be pre-written in text form and used as model configuration information corresponding to the task-oriented dialogue model. Thus, for a question input by a user, the task-oriented dialogue model can directly generate a corresponding answer based on the model configuration information, meaning only one large language model call is needed to complete a round of dialogue, thereby reducing latency and improving dialogue efficiency. Moreover, the generated answer is natural and fluent, enhancing the user's dialogue experience. Additionally, the dialogue flow can be written in text form, which is very simple and convenient, thus lowering the usage threshold of the task-oriented dialogue model and saving human resource and time costs.

In some embodiments of the present disclosure, the dialogue flow may include: a dialogue flow written for a predetermined dialogue scenario, correspondingly, the question acquired by the question acquisition module 501 may be a question under the dialogue scenario.

The dialogue flow can be written according to a predetermined writing format. In some embodiments of the present disclosure, the dialogue flow may include: at least two steps written according to a predetermined step writing principle, where each step may include: the objective to be achieved by the step, and the requirement to be followed for achieving the objective.

The specific content included in the step writing principle can be determined according to actual needs. For example, steps can be written according to the principle that fewer steps in the dialogue flow are better, and clearer boundaries between steps are better.

In addition to the dialogue flow, in some embodiments of the present disclosure, the model configuration information may also include: at least one external tool corresponding to the task-oriented dialogue model. Correspondingly, the answer corresponding to the question input by the first user may include: an answer directly generated by the task-oriented dialogue model in response to determining that no external tool is needed, and an answer generated by the task-oriented dialogue model in combination with obtained external data in response to determining that an external tool is needed, where the external data is invocation result data obtained by the task-oriented dialogue model through invoking the external tool.

Additionally, in some embodiments of the present disclosure, in response to determining that the external tool includes an external tool requiring material configuration, the model configuration information may also include: textual resource information configured for the external tool requiring material configuration.

FIG. 6 is a schematic diagram showing the composition structure of a task-oriented dialogue model training apparatus 600 according to an embodiment of the present disclosure.

As shown in FIG. 6, the apparatus includes a sample acquisition module 601 and a model training module 602.

The sample acquisition module 601 is configured to acquire training samples corresponding to the task-oriented dialogue model.

The model training module 602 is configured to train the task-oriented dialogue model using the training samples, where the task-oriented dialogue model is used to generate an answer corresponding to a question to be answered according to corresponding model configuration information, where the model configuration information includes a dialogue flow corresponding to the task-oriented dialogue model, where the dialogue flow is written in text form.

By adopting the solution described in the above apparatus embodiment, the task-oriented dialogue model can be trained using acquired training samples.

After training, a dialogue flow can be pre-written in text form and used as model configuration information corresponding to the task-oriented dialogue model. Thus, for questions input by users, the task-oriented dialogue model can directly generate corresponding answers based on the model configuration information, meaning only one large language model call is needed to complete a round of dialogue, thereby reducing latency and improving dialogue efficiency. Moreover, the generated answer is natural and fluent, enhancing the user's dialogue experience. Additionally, the dialogue flow can be written in text form, which is very simple and convenient, thus lowering the usage threshold of the task-oriented dialogue model and saving human resource and time costs.

In some embodiments of the present disclosure, the training samples may include: a first type of training samples, each set of the first type of training samples may include: a question, a dialogue flow of the dialogue scenario corresponding to the question, an answer corresponding to the question, and intermediate reasoning process information needed by the task-oriented dialogue model for generating the answer.

In some embodiments of the present disclosure, the training samples may also include: a second type of training samples, each set of the second type of training samples may include: a question, a dialogue flow of the dialogue scenario corresponding to the question, a name and function description information of an external tool usable by the task-oriented dialogue model, an answer corresponding to the question generated in combination with external data, and intermediate reasoning process information needed by the task-oriented dialogue model for generating the answer, where the external data is invocation result data obtained through invoking the external tool.

Additionally, in some embodiments of the present disclosure, the dialogue flow may include: at least two steps written according to a predetermined step writing principle, where each step may include: an objective to be achieved by the step, and a requirement to be followed for achieving the objective.

After constructing sufficient training samples, the model training module 602 can train the task-oriented dialogue model using the training samples. After training is completed, the task-oriented dialogue model can be applied to actual task-oriented dialogues, such as generating answers corresponding to questions to be answered according to corresponding model configuration information.

The specific workflow of the apparatus embodiments shown in FIGS. 5 and 6 can refer to the relevant descriptions in the preceding method embodiments, which will not be repeated here.

The solution described in the present disclosure can be applied to the field of artificial intelligence, particularly involving areas such as deep learning, large language models, natural language processing, and intelligent agents. Artificial intelligence is a discipline that studies how to make computers simulate certain human thinking processes and intelligent behaviors (such as learning, reasoning, thinking, planning, etc.), including both hardware and software technologies. Artificial intelligence hardware technology generally includes technologies such as sensors, specialized AI chips, cloud computing, distributed storage, big data processing, etc. Artificial intelligence software technology mainly includes several major directions such as computer vision technology, speech recognition technology, natural language processing technology, machine learning/deep learning, big data processing technology, and knowledge graph technology.

The question and answer mentioned in the embodiments of the present disclosure are not targeted at any specific user and do not reflect personal information of any specific user. Additionally, the executing subject of the methods described in this disclosure can obtain the question through various public, legal, and compliant means, such as obtaining from a user after authorization. In the technical solutions of this disclosure, the collection, storage, use, processing, transmission, provision, and disclosure of user personal information involved all comply with relevant laws and regulations, and do not violate public order and good morals.

According to embodiments of the present disclosure, the present disclosure also provides an electronic device, a readable storage medium, and a computer program product.

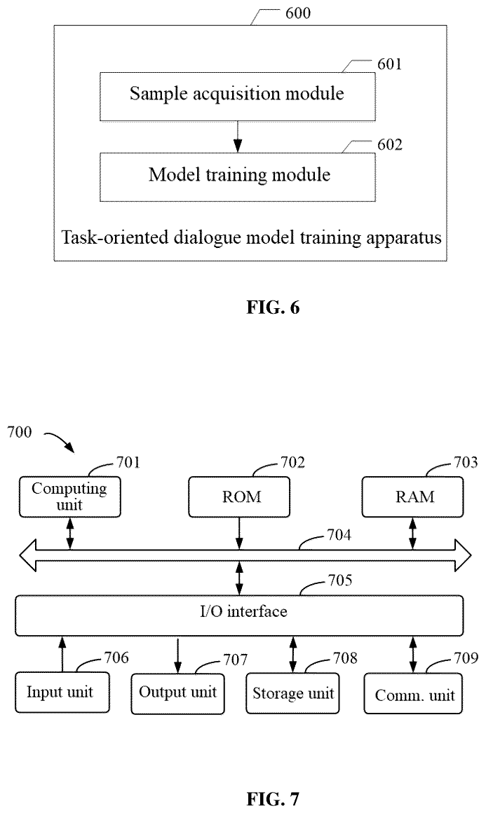

FIG. 7 shows a schematic block diagram of an electronic device 700 that can be used to implement embodiments of the present disclosure. The electronic device is intended to represent various forms of digital computers, such as laptops, desktop computers, workstations, servers, blade servers, mainframes, and other suitable computers. The electronic device can also represent various forms of mobile devices, such as personal digital assistants, cellular phones, smartphones, wearable devices, and other similar computing devices. The components shown here, their connections and relationships, and their functions are meant merely as examples and are not intended to limit implementations of the disclosure described and/or claimed in this document.

As shown in FIG. 7, the electronic device 700 includes a computing unit 701, which can execute various appropriate actions and processing according to computer programs stored in Read-Only Memory (ROM) 702 or computer programs loaded from storage unit 708 to Random Access Memory (RAM) 703. Various programs and data needed for the operation of electronic device 700 can also be stored in RAM 703. The computing unit 701, ROM 702, and RAM 703 are interconnected through bus 704. Input/Output (I/O) interface 705 is also connected to bus 704.

Multiple components in the electronic device 700 are connected to the I/O interface 705, including: an input unit 706, such as a keyboard, a mouse, etc.; an output unit 707, such as various types of displays, speakers, etc.; a storage unit 708, such as a magnetic disk, an optical disk, etc.; and a communication unit (comm. unit) 709, such as a network card, a modem, a wireless communication transceiver, etc. The communication unit 709 allows the electronic device 700 to exchange information/data with other devices through computer networks such as the Internet and/or various telecommunications networks.

The computing unit 701 can be various general-purpose and/or specialized processing components with processing and computing capabilities. Some examples of the computing unit 701 include but are not limited to Central Processing Unit (CPU), Graphics Processing Unit (GPU), various specialized Artificial Intelligence (AI) computing chips, various computing units running machine learning model algorithms, Digital Signal Processing (DSP), and any appropriate processors, controllers, microcontrollers, etc. The computing unit 701 executes the various methods and processes described above, such as the methods described in this disclosure. For example, in some embodiments, the methods described in this disclosure can be implemented as computer software programs that are tangibly included in machine-readable media, such as the storage unit 708. In some embodiments, part or all of the computer programs can be loaded and/or installed onto the electronic device 700 via ROM 702 and/or the communication unit 709. When the computer program is loaded into RAM 703 and executed by the computing unit 701, one or more steps of the methods described in this disclosure can be executed. Alternatively, in other embodiments, the computing unit 701 can be configured to execute the methods described in this disclosure through any other appropriate means (for example, through firmware).

The various implementations of the systems and techniques described herein can be realized in digital electronic circuit systems, integrated circuit systems, Field Programmable Gate Arrays (FPGA), Application Specific Integrated Circuits (ASIC), Application Specific Standard Parts (ASSP), System on Chip (SOC), Complex Programmable Logic Devices (CPLD), computer hardware, firmware, software, and/or combinations thereof. These various implementations may include: implementation in one or more computer programs that can be executed and/or interpreted on a programmable system including at least one programmable processor, which can be special or general purpose, capable of receiving data and instructions from a storage system, at least one input device, and at least one output device, and transmitting data and instructions to the storage system, the at least one input device, and the at least one output device.

The program code for implementing the methods of the present disclosure can be written in any combination of one or more programming languages. These program codes can be provided to a processor or a controller of a general-purpose computer, a special-purpose computer, or other programmable data processing device, such that when the program code is executed by the processor or controller, the functions/operations specified in the flowcharts and/or block diagrams are implemented. The program code can be executed entirely on the machine, partly on the machine, partly on the machine as a standalone software package and partly on a remote machine, or entirely on the remote machine or server.

In the context of the present disclosure, a machine-readable medium can be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus or devices, or any suitable combination thereof. More specific examples of machine-readable storage media would include an electrical connection based on one or more wires, a portable computer disk, a hard disk, random access memory, read-only memory, Electronically Programmable Read-Only Memory (EPROM), flash memory, optical fiber, Compact Disc Read-Only Memory (CD-ROM), optical storage devices, magnetic storage devices, or any suitable combination thereof.

To provide interaction with a user, the systems and techniques described here can be implemented on a computer having a display device (e.g., a Cathode Ray Tube (CRT) or Liquid Crystal Display (LCD) monitor) for displaying information to the user, and a keyboard and pointing device (e.g., a mouse or trackball) by which the user can provide input to the computer. Other kinds of devices can be used to provide interaction with users; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a user computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include a Local Area Network (LAN), a Wide Area Network (WAN), and the Internet.

A computer system can include a clients and a server. The client and the server are generally remote from each other and typically interact through a communication network. The relationship between client and server is created by computer programs running on their respective computers and having a client-server relationship with each other. The server may be a cloud server, or a server in a distributed system, or a server integrated with blockchain.

It should be understood that the various forms of processes shown above can be reordered, steps can be added or deleted. For example, the various steps recorded in this disclosure can be executed in parallel or sequentially or in different orders, as long as they can achieve the desired results of the technical solution disclosed in this disclosure, no limitation is made herein.

The above specific embodiments do not constitute limitations on the scope of protection of this disclosure. Those skilled in the art should understand that various modifications, combinations, sub-combinations and substitutions can be made according to design requirements and other factors. Any modifications, equivalent substitutions and improvements made within the spirit and principles of this disclosure should be included within the scope of protection of this disclosure.

What is claimed is:

1. A task-oriented dialogue implementation method, comprising:
acquiring a question to be answered; and
generating an answer corresponding to the question by using a task-oriented dialogue model, wherein the answer is generated by the task-oriented dialogue model according to model configuration information, wherein the model configuration information comprises a dialogue flow corresponding to the task-oriented dialogue model, wherein the dialogue flow is written in text form.

2. The method according to claim 1, wherein,
the dialogue flow comprises a dialogue flow written for a predetermined dialogue scenario; and
the question is a question under the dialogue scenario.

3. The method according to claim 1, wherein,
the dialogue flow comprises at least two steps written according to a predetermined step writing principle;
each of the steps comprises: an objective to be achieved by the step, and a requirement to be followed for achieving the objective.

4. The method according to claim 1, wherein,
the model configuration information further comprises at least one external tool corresponding to the task-oriented dialogue model;
the answer comprises: an answer directly generated by the task-oriented dialogue model in response to determining that the external tool is not needed, and an answer generated by the task-oriented dialogue model in combination with obtained external data in response to determining that the external tool is needed, wherein the external data is invocation result data obtained by the task-oriented dialogue model through invoking the external tool.

5. The method according to claim 4, wherein,
in response to determining that the external tool comprises an external tool requiring material configuration, the model configuration information further comprises: textual resource information configured for the external tool requiring material configuration.

6. The method according to claim 1, wherein the task-oriented dialogue model is trained by:
acquiring training samples corresponding to the task-oriented dialogue model; and
training the task-oriented dialogue model using the training samples.

7. The method according to claim 6, wherein,
the training samples comprise a first type of training samples;
wherein each set of the first type of training samples comprises: a question, a dialogue flow of a dialogue scenario corresponding to the question, an answer corresponding to the question, and intermediate reasoning process information needed by the task-oriented dialogue model for generating the answer.

8. The method according to claim 7, wherein,
the training samples further comprise a second type of training samples;
wherein each set of the second type of training samples comprises: a question, a dialogue flow of a dialogue scenario corresponding to the question, a name and function description information of an external tool usable by the task-oriented dialogue model, an answer corresponding to the question generated in combination with external data, and the intermediate reasoning process information, wherein the external data is invocation result data obtained through invoking the external tool.

9. An electronic device, comprising:
at least one processor; and
a memory communicatively connected to the at least one processor;
wherein the memory stores instructions executable by the at least one processor to cause the at least one processor to perform the method according to a task-oriented dialogue implementation method, which comprises:
acquiring a question to be answered; and
generating an answer corresponding to the question by using a task-oriented dialogue model, wherein the answer is generated by the task-oriented dialogue model according to model configuration information, wherein the model configuration information comprises a dialogue flow corresponding to the task-oriented dialogue model, wherein the dialogue flow is written in text form.

10. The electronic device according to claim 9, wherein,
the dialogue flow comprises a dialogue flow written for a predetermined dialogue scenario; and
the question is a question under the dialogue scenario.

11. The electronic device according to claim 9, wherein,
the dialogue flow comprises at least two steps written according to a predetermined step writing principle;
each of the steps comprises: an objective to be achieved by the step, and a requirement to be followed for achieving the objective.

12. The electronic device according to claim 9, wherein,
the model configuration information further comprises at least one external tool corresponding to the task-oriented dialogue model;
the answer comprises: an answer directly generated by the task-oriented dialogue model in response to determining that the external tool is not needed, and an answer generated by the task-oriented dialogue model in combination with obtained external data in response to determining that the external tool is needed, wherein the external data is invocation result data obtained by the task-oriented dialogue model through invoking the external tool.

13. The electronic device according to claim 12, wherein,
in response to determining that the external tool comprises an external tool requiring material configuration, the model configuration information further comprises: textual resource information configured for the external tool requiring material configuration.

14. The electronic device according to claim 9, wherein the task-oriented dialogue model is trained by:
acquiring training samples corresponding to the task-oriented dialogue model; and
training the task-oriented dialogue model using the training samples.

15. The electronic device according to claim 14, wherein,
the training samples comprise a first type of training samples;
wherein each set of the first type of training samples comprises: a question, a dialogue flow of a dialogue scenario corresponding to the question, an answer corresponding to the question, and intermediate reasoning process information needed by the task-oriented dialogue model for generating the answer.

16. The electronic device according to claim 14, wherein,
the training samples further comprise a second type of training samples;
wherein each set of the second type of training samples comprises: a question, a dialogue flow of a dialogue scenario corresponding to the question, a name and function description information of an external tool usable by the task-oriented dialogue model, an answer corresponding to the question generated in combination with external data, and the intermediate reasoning process information, wherein the external data is invocation result data obtained through invoking the external tool.

17. A non-transitory computer-readable storage medium storing computer instructions for causing a computer to perform a task-oriented dialogue implementation method which comprises:
acquiring a question to be answered; and
generating an answer corresponding to the question by using a task-oriented dialogue model, wherein the answer is generated by the task-oriented dialogue model according to model configuration information, wherein the model configuration information comprises a dialogue flow corresponding to the task-oriented dialogue model, wherein the dialogue flow is written in text form.

18. The storage medium according to claim 17, wherein,
the dialogue flow comprises a dialogue flow written for a predetermined dialogue scenario; and
the question is a question under the dialogue scenario.

19. The storage medium according to claim 17, wherein,
the dialogue flow comprises at least two steps written according to a predetermined step writing principle;
each of the steps comprises: an objective to be achieved by the step, and a requirement to be followed for achieving the objective.

20. The storage medium according to claim 1, wherein,
the model configuration information further comprises at least one external tool corresponding to the task-oriented dialogue model;
the answer comprises: an answer directly generated by the task-oriented dialogue model in response to determining that the external tool is not needed, and an answer generated by the task-oriented dialogue model in combination with obtained external data in response to determining that the external tool is needed, wherein the external data is invocation result data obtained by the task-oriented dialogue model through invoking the external tool.
